(19) United States
(12) Patent Application Publication
(10) Pub. No.: US 2019/0066159 A1
(43) Pub. Date: Feb. 28, 2019

(54) Motor Vehicle Maintenance Tracking System and Method

(71) Applicant: Jimmy Caudillo, Murrieta, CA (US)

(72) Inventor: Jimmy Caudillo, Murrieta, CA (US)

(21) Appl. No.: 16/052,502

(22) Filed: Aug. 1, 2018

Related U.S. Application Data
(60) Provisional application No. 62/539,880, filed on Aug. 1, 2017.

(51) Int. Cl. G06Q 30/02; G07C 5/08; G07C 5/00; G06Q 10/00

(52) U.S. Cl. CPC G06Q 30/0265; G07C 5/085; G06Q 10/20; G07C 5/0808; G07C 5/008

(57) ABSTRACT

A vehicle maintenance tracking system provides a device for tracking vehicle usage and diagnostics and transmitting the collected usage and diagnostics data to a vehicle maintenance tracking server. The vehicle maintenance tracking server forms part of a customer relationship management (CRM) platform, which calculates appropriate vehicle service schedules and provides vehicle maintenance and diagnostics alerts and reports to the customer and auto dealer, and targeted marketing tailored toward the customer's interests and needs. The targeted marketing platform measures success rates at the macro (overall) and micro (individual customer) levels, and allows for the analysis of both vehicle use and customer online behavior.

### RELATED APPLICATIONS

This application claims the benefit of priority to U.S. Provisional Patent Application Ser. No. 62/539,880, for an invention entitled “Motor Vehicle Maintenance Tracking System and Method”, filed Aug. 1, 2017, and currently co-pending and the entirety of which is fully incorporated herein by this reference.

### FIELD OF THE INVENTION

The present invention pertains generally to a system for tracking motor vehicle use and scheduling maintenance. More particularly, the present invention pertains to a device which collects diagnostic data provided by the internal computer of a motor vehicle, tracks movement of a motor vehicle, and communicates the collected diagnostic and mileage data to a central server which enables a vendor to determine maintenance needs and send reminders to the vehicle owner. The present invention is particularly, but not exclusively, useful for maintaining a relationship between an auto dealer and its customers, and notifying the customers of the maintenance needs of their vehicles.

### BACKGROUND OF THE INVENTION

Motor vehicle service is often the largest source of profits for an auto dealership, exceeding vehicle sales and warranty service. Regular service that should be performed on a vehicle includes oil changes, tune-ups, fluid and tire pressure checks, inspection, and other light maintenance. A complete record of a vehicle's service may significantly increase its resale value, so regular visits to a dealership's service department provides significant benefits to the consumer as well.

A dealership's service center also provides the customer with the benefits of a depth of experience: their service staff tends to enjoy specialized training, including proprietary information, for the particular brand of vehicle sold by the dealer. Independent service providers and mechanics require a greater breadth of knowledge to work on a wide variety of vehicles, limiting the depth of knowledge and skill available for a particular customer's vehicle.

Thus both dealers and customers have a significant reason to maintain an ongoing relationship. Nonetheless, unsophisticated customers may be unaware of the benefits of regular dealer service and may not always know when their vehicle needs service. Dealerships are limited in their ability to remind their customers of upcoming service by a lack of detailed information about the customer's driving habits or the state of the vehicle at any given time. Thus, in order to maintain a close relationship and attract a customer back for service, a dealership is limited to activities such as sending out holiday cards or reminders based on estimated service dates.

Various problems arise in the use of estimated service dates. Vehicle owners vary in the frequency and distance of their driving. Thus an estimated date may be too early for some customers, and far too late for others. Additionally, the appropriate service schedule may vary depending on the type of driving in which the customer engages. For example, constant stop-and-go driving on city streets or regular off-roading may result in the vehicle requiring much more frequent service than highway driving. Climate and weather conditions may also affect the appropriate service schedule, making the locations and time of driving relevant. Presently, a dealership only has access to this information if it is provided directly by the customer. The information can also become outdated if the customer's driving habits change.

Dealerships will often use Customer Relationship Management (CRM) software in order to optimize their efforts at maintaining a mutually beneficial dealership-customer relationship. CRM software has become ubiquitous in virtually all industries in recent decades. In the auto marketplace, it allows dealers to keep track of important information about customers, including purchase history and dates. Alerts can be programmed at predetermined intervals, enabling the dealership to send out service reminders to customers when it is estimated that certain mileages will be reached on the vehicle. Other alerts may remind the dealership to reach out to a customer to wish him or her a “happy birthday” or something similar on an appropriate date. Even with the benefits of CRM software estimating and automating reminders, the dealership is still limited by the amount of data acquired through contact with its customers.

Some newer vehicles will notify owners of upcoming service needs with dashboard lights or information on a dashboard's digital display. The reminders help customers' awareness of maintenance needs, but their value for the dealer-client relationship is limited. A customer may see the notification and take the car for service at an independent service center. The dealership thus loses the opportunity to provide the service, and the customer loses the benefit of a close relationship with the dealership. Moreover, the use of independent service centers leaves the dealership's service records for the vehicle incomplete, which may diminish the value of the vehicle for sale or trade-in.

In order to attract customers to bring their vehicles in for service, some dealerships attempt to make up for the above-noted limitations by providing incentives for customers to bring in their cars for regular service. For example, a dealership may offer free batteries or free tires for the life of a vehicle, provided that it is consistently brought in for regularly scheduled service. Such incentives can quickly become costly to the dealership, and of themselves don't notify the customer at the time service is needed.

Companies such as Carfax provide vehicle history reports which may partially make up for gaps in dealership service records. Vehicle history reports attempt to reconstruct the history of a car based on title information, service records from dealerships or independent service centers that provide information, and accident reports, among other sources. The available information may be incomplete, however, depending on what information is available.

Some vehicle owners may even make active efforts to limit the information available in order to avoid lowering the resale value of the vehicle. One way in which information is kept from vehicle history reports is the selection, for certain repairs, of mechanics who don't report information. Furthermore, residents near the southern United States border sometimes take their vehicles into Mexico for repairs. Some seek repairs outside of the United States to benefit from lower labor costs; others may do so to avoid the repairs showing up on their vehicle history reports. Additionally, to some buyers, a vehicle history report is not an adequate substitute for a complete dealership service history.

In light of the above, it would be advantageous to provide a way to notify dealerships of a vehicle's mileage, diagnostics, type of usage, and other maintenance-related information in order to more accurately track service needs and notify customers at the appropriate time. It would be further advantageous to integrate data provided by vehicle usage tracking into CRM software to improve the calculation of appropriate service schedules. It would be further advantageous to provide the vehicle usage tracking information at frequent intervals or in real-time in order to maintain up-to-date information and allow notifications or reminders to be sent to customers at the appropriate times. It would be further advantageous to provide vehicle usage tracking information which can determine the type of driving and driving conditions, allowing the creation and regular adjustment of an appropriate service schedule for the vehicle. Finally, it would be advantageous for the vehicle tracking to be integrated into the vehicle itself, so that it can take place automatically to provide the needed reminders and alerts to dealerships and customers.

### SUMMARY OF THE INVENTION

The present invention provides a system for recording and analyzing customer behavior and providing targeted marketing in order to maintain between the customer and a vendor, generally an auto dealer. A preferred embodiment provides a combination of email, website, and vehicle usage tracking. Based on the collected information, targeted marketing can be provided based on the service needs of the customer's vehicle, customer interests including new vehicle purchases, and additional customer information such as family size and makeup, and birthdays.

A preferred embodiment of the present invention provides an apparatus for tracking vehicle usage, referred to herein as a “vehicle usage tracker.” The vehicle usage tracker connects to the OBD port of the vehicle. The OBD port is the port that communicates with the vehicle's on-board computer to receive “on-board diagnostics.” Cars manufactured in the United States for domestic sale have used the OBD-II standard for the OBD port and the communication protocol used over the OBD port since 1996. Other standards also exist, such as EOBD in Europe, and JOBD in Japan. As used herein, the term “OBD” is contemplated to include ports and protocols corresponding to any of the on-board diagnostic standards, as embodiments of the present invention may be designed for use with various versions of the standard. For example, the OBD-II standard is followed in exemplary embodiments of the vehicle usage tracker intended for use with U.S. vehicles manufactured since 1996, and in other markets in which vehicles generally use the same standard. The EOBD standard is used with certain embodiments intended for the European market, while the JOBD standard is used with embodiments of the vehicle usage tracker intended for use in Japan. The ADR 79/02 standard, which is similar to the OBD-II standard, is used in some embodiments intended for the Australian market. Notwithstanding the OBD port being a convenient installation point for the vehicle usage tracker, some embodiments of the present invention may also include a vehicle usage tracker fully integrated into the vehicle's on-board computer, or a vehicle usage tracker installed in other ways.

The vehicle usage tracker, in addition to the connector for the OBD port, has a GPS receiver, a controller, a memory, a serial number identifying the vehicle usage tracker, and a transmitter. The controller, which may be a programmable microcontroller, runs software designed to communicate with the vehicle's on-board computer through the OBD port to retrieve and log diagnostic data. The software also retrieves and logs GPS data through the GPS receiver. The vehicle usage tracker uses the transmitter to provide the diagnostic and GPS data to a vehicle maintenance tracking server, in association with the vehicle usage tracker's serial number. The vehicle maintenance tracking server is then able to use the diagnostic data to determine any pending maintenance needs. The diagnostic data in conjunction with the GPS data also allows the vehicle maintenance tracking server to determine the amount and type of use. Since the GPS data provides the locations in which the vehicle is used, it can be compared with climate data as well. Thus mileage, type of use, and climate can be considered in determining the appropriate maintenance schedule for the vehicle.

The vehicle maintenance tracking server associates the data provided by the vehicle usage tracker with a customer. In many cases, the customer's identifying information and the corresponding vehicle usage tracker serial number is provided by the dealer which installed the vehicle usage tracker in the vehicle. The customer identifying data generally includes an email address, so if the diagnostic data shows any problems with the vehicle, or if the vehicle maintenance tracking server determines that the vehicle is due for scheduled maintenance, an email alert may be automatically sent to the customer. Additionally—or alternatively—an alert may be provided to the dealer or other user of the invention via email or through back office functionality so that the dealer or user may reach out to the customer directly.

In an exemplary embodiment of the present invention, the vehicle usage tracker and the vehicle maintenance tracking server form part of a complete customer relationship management (“CRM”) system and marketing platform. The customer identifying data may include any information collected by the dealer, including family size, birthdates of customers or customers' family members, purchase history, and so forth. This information can be used to provide alerts to the dealer or user of the invention in order to reach out to the customer at appropriate times, such as to wish the customer a happy birthday, and thus maintain an ongoing relationship with the customer. The customer identifying data is stored in a database in communication with the vehicle maintenance tracking server and/or other servers on which the CRM system and marketing platform run. At regular intervals, the CRM system accesses records from the database having an important upcoming event in order to provide an alert to the dealer or user, or to automatically send a communication, such as an email, to the customer.

In conjunction with the marketing aspect of the present invention, an exemplary embodiment includes one or more ways to track the effectiveness of marketing efforts. For example, it is often desirable to know how successful a targeted email campaign is. Thus, an email may include an image that needs to be loaded from an external server, such as the vehicle maintenance tracking server or another server connected to its database. The image may be related to the email content, e.g. the dealer's logo, but is often a one (1) pixel by one (1) pixel image that is effectively invisible to the customer. When the customer opens the email, an HTTP request for the image is sent to the external server. Upon receiving the request, the external server sends the image and records the customer's IP address. The URL used for the image request may also include information identifying the customer and/or the particular email. In such cases, this information is also stored. Some email clients do not load external images by default, so links inside the email may direct the customer to an intermediate page which immediately redirects to customer to the target website. The URL for the intermediate page is an external server, such as the vehicle maintenance tracking server or another server connected to its database, and records the customer's IP address and any customer and/or email identifying information in the URL. The external server then responds to the HTTP request with a 301 status code (or another appropriate redirect code in the 300-399 range) and the URL of the target website.

The overall click-through rate can be calculated by dividing the number of requests for the intermediate page by the number of emails sent. This number can be made more accurate if the intermediate page URL identifies the original email message, and each request for a specific URL is only counted once, eliminating double-counting customers who click the links more than once. As long as the email message is identified by both the image request and the intermediate page request, an approximate click-through rate can be calculated for those emails which have been opened by customers. The approximate click-through rate for opened email messages is the number of unique requests for an intermediate page from emails for which an image request has been sent, divided by the number of emails for which an image request has been sent. By “unique request” it is meant that only the first request from each email message is counted. By dividing the number of unique intermediate page requests from all emails—both those having image requests and those not having image requests—by the approximate click-through rate for opened email messages, the approximate number of total opened email messages is determined. Dividing the approximate number of total opened email messages by the total number of email messages sent in a campaign provides the email open rate, or the portion of emails that are opened by customers. A low email open rate suggests that many email messages are ending up in SPAM folders or that customers are ignoring the messages based either on the sender or the subject line. A high email open rate but a low click-through rate suggests that the body of the email message is failing to persuade customers to access the provided links. Marketing campaign efforts can be adjusted based on the calculated email open rates and click-through rates.

Additionally, the dealer's website may provide additional data of use in determining the success of email campaigns and the particular interests of each customer. In conjunction with the system of the present invention, a script may be provided for the dealer's website, which uses an API to access an external server, such as the vehicle maintenance tracking server or another server connected to its database, and provide the IP address of visitors. The IP address is then compared to the customer IP addresses collected via email marketing efforts. If there is a match, the success rate of the email campaign may be further measured by the customer's activity and purchases on the dealer website. Data collected from the customer's activity on the dealer website—such as which pages are visited—provides information which may be used to determine the customer's interests. For example, if the customer browses primarily SUVs and minivans, future marketing efforts toward that customer may focus on SUVs and minivans. Other information originally provided by the dealer, such as family size and prior purchases, may also be used as a factor in determining the appropriate focus of marketing efforts to the customer.

Finally, an email campaign may be run with a purchased or provided email address list of potential customers. For example, the user of the present invention may purchase a list of email addresses belonging to individuals who have previously shown an interest in purchasing a vehicle. Alternatively, the user may have acquired a list of prospective customers through its own promotional efforts. A marketing email may be sent out with the tracking mechanisms described above. An IP address is collected when the email is opened, and an IP address is collected from the target website. In addition to IP addresses, the target website provides email addresses and other customer identifying information from sales. Where IP addresses or email addresses from the dealer website match IP or email addresses from the marketing campaign, those sales have been generated through the email marketing campaign.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a diagram showing the motor vehicle maintenance tracking system of the present invention;

FIG. 2 is a diagram showing an individual motor vehicle tracking module of the present invention and its interaction with the vehicle's computer, the GPS satellite system, and the rest of the motor vehicle maintenance tracking system of the present invention;

FIG. 3 is a diagram showing the customer IP capturing module of the dealer website and its interaction with the vehicle maintenance tracking server;

FIG. 4 is a continuation of the diagram of FIG. 3 and shows the actions initiated on the vehicle maintenance tracking server when the IP capturing module of FIG. 3 makes an API call to the vehicle maintenance tracking server;

FIG. 5 is a diagram of one process of obtaining a customer IP address when a marketing email is viewed as implemented on a preferred embodiment of the vehicle maintenance tracking server of the present invention;

FIG. 5A is a diagram of the process shown in FIG. 5 as implemented on an Apache web server running PHP; and

FIG. 6 is a continuation of the diagram of FIG. 5 and shows the process of matching the customer's identity between marketing email and dealer website accesses as implemented in a preferred embodiment of the vehicle maintenance tracking server of the present invention.

### DETAILED DESCRIPTION

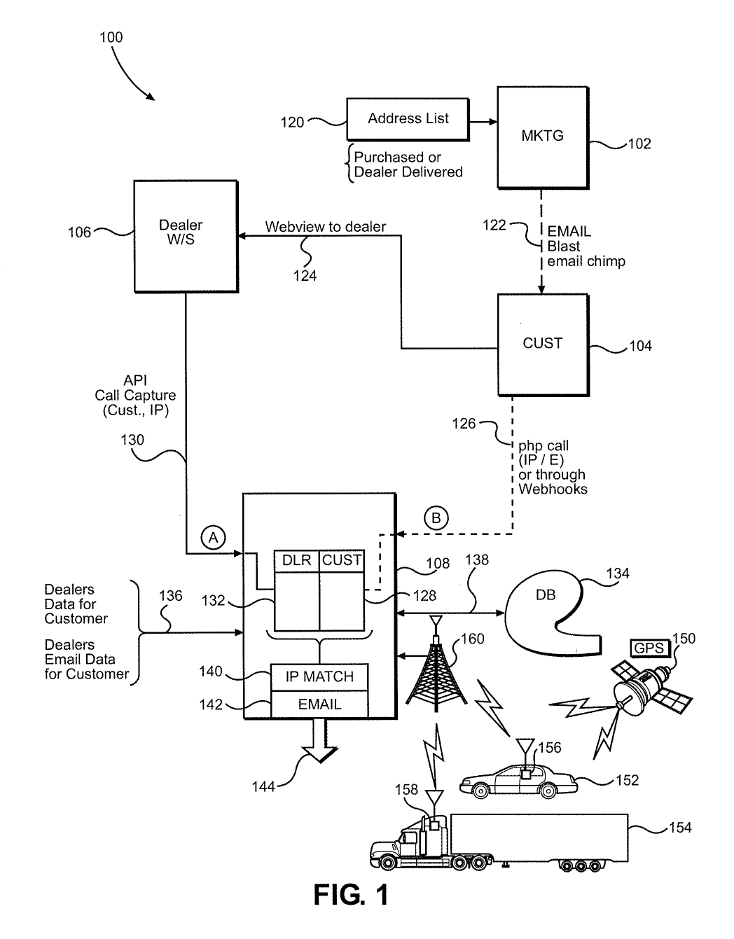

Referring initially to FIG. 1, a vehicle maintenance tracking system is depicted and generally designated 100. The vehicle maintenance tracking system 100 uses a marketing platform 102 which communicates with customers 104. Customers 104 are directed to a website 106 of their auto dealer, which provides customer identity data, including the customer IP address to a vehicle maintenance tracking server 108. The vehicle maintenance tracking server 108 then tries to match the customer identified by the dealer website 106 with identity data, including the customer IP address, obtained directly from the customer 104 through internet communications, such as email messages. The functionality of the vehicle maintenance tracking server 108 may also be implemented in a collection of servers rather than a single server.

A customer list 120, containing customer addresses, email addresses, or both, is provided by an auto dealer or otherwise purchased. The address list 120 is provided to the marketing platform 102 and used to send marketing materials to customers 104. The marketing materials sent to customers 104 may include an email message 122. When the email message 122 is opened by the customer 104, an HTTP request 126 to the vehicle maintenance tracking server 108 is initiated, as the customer's email client attempts to download an image associated with the email message 122. The vehicle maintenance tracking server 108 acquires the IP address of the customer 104 via the HTTP request and stores customer identifying information along with the IP address in a customer data table 128 while it delivers the requested image. The email message 122 may be sent through a third-party mass email sending service in situations in which it may be more efficient to offload sending the emails onto a third party. In some cases of third-party services, email open and click data is provided by the third party service rather than through an in-house process involving an image request. References herein to IP addresses obtained through email views are contemplated to refer both to IP addresses obtained via image requests and IP addresses obtained from third-party email services.

When the customer 104 navigates to the dealer's website 106, a script on the dealer's website 106 makes an API call 130 to the vehicle maintenance tracking server 108. The API call 130 allows the vehicle maintenance tracking server 108 to capture the identifying information, including the IP address, of the customer 104 and place it in a dealer data table 132. The IP addresses corresponding to email addresses from the customer data table, as well as the IP addresses and other data from the dealer data table are stored in a database 134. An IP address sent to the vehicle maintenance tracking server 108 through the API call 130 is compared to the IP addresses from the customer data table 128. If there is a match, the corresponding visit to the dealer website has been generated through the email marketing campaign associated with the email message 122.

Customer data 136, including email addresses, from the dealer is communicated to the vehicle maintenance tracking server 108. Customer data 136 will generally be associated with a sale that has been made. The email address is compared to the existing email and IP data originally collected in the customer data table 128 and the dealer data table 132. A match indicates that the corresponding sale has been generated through the email marketing campaign. A data link 138 between the vehicle maintenance tracking server 108 and the database 134 allows for the storage and retrieval of information from the customer data table 128, the dealer data table 132, and the dealer collected customer data 136. In this way, the vehicle maintenance tracking server 108 is able to store data, calculate and analyze statistics, and prepare reports on the email marketing campaign and its effectiveness in generating both website visits and sales.

In addition to measuring the effectiveness of a marketing campaign toward closing an initial sale, it is useful to maintain an ongoing, mutually beneficial relationship between the dealer and the customer in order to keep a vehicle in optimum condition and maintain complete service records. In order to facilitate the ongoing relationship between dealer and client, information about the vehicle's use is collected so that maintenance service can be scheduled at the appropriate times.

The appropriate maintenance schedule for a vehicle depends on the distance driven, the style of driving, and the climate in which the vehicle is driven, among other factors. On-board diagnostics data is collected and used in determining both upcoming and urgent maintenance needs. However, in addition to the on-board diagnostics data from the vehicle's on-board computer, location data is also acquired from the global positioning system, or GPS 150. In an exemplary embodiment, GPS data for a vehicle is acquired and stored once every five minutes.

The vehicle use tracking of the present invention works equally well with personal vehicles such as a car 152, or with commercial vehicles such as a truck 154. Each vehicle being tracked is equipped with a vehicle usage tracker, shown here as a tracker 156 attached to the car 152, and a tracker 158 attached to the truck 154. The vehicle usage tracker 156 sends the captured GPS data, the captured on-board diagnostics data, and vehicle and tracker identifying data to the vehicle maintenance tracking server 108 through a receiver 160. The vehicle usage tracker 158 of the truck 154 also sends GPS, diagnostics, and vehicle and tracker identifying data corresponding to the truck 154 to the vehicle maintenance tracking server 108 through the same receiver 160.

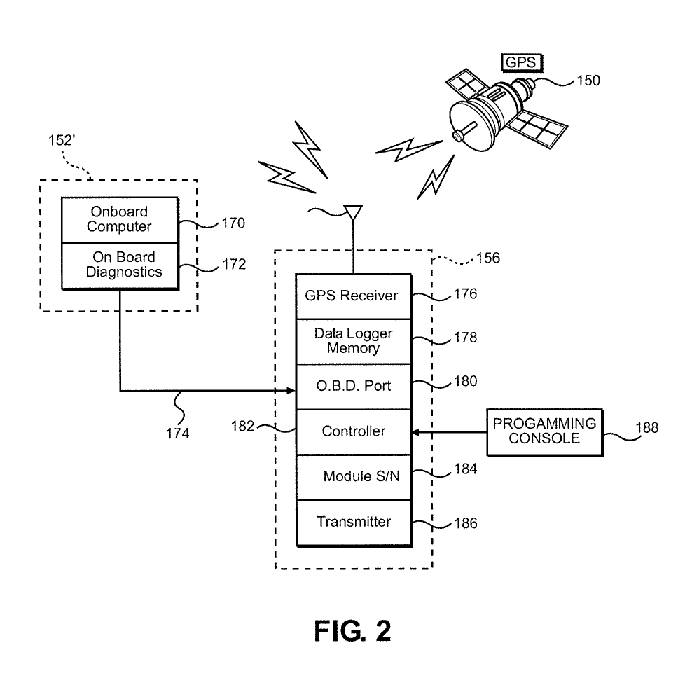

Referring now to FIG. 2, a diagram of the components of the vehicle usage tracker 156 is shown. The vehicle 152 has a vehicle computer system 152′ which includes an on-board computer 170 and an on-board diagnostics (“OBD”) interface 172 allowing for a connection 174 between the on-board computer 170 and an external device such as an OBD reader. The vehicle usage tracker 156 is generally installed into the vehicle 152 by the dealer, and connects to the vehicle's OBD interface 172. The vehicle usage tracker 156 includes a GPS receiver 176, a memory 178, an OBD port 180, a programmable controller 182, a serial number 184, and a transmitter 186. The programmable controller 182 runs software which retrieves location data from GPS satellites 150 through the GPS receiver 176, and diagnostics data through the OBD connection 174 from the OBD port 180 at regular intervals, and stores both the location data and the diagnostics data in the memory 178. The software running on the controller also operates the transmitter 186 to regularly transmit the collected data and serial number to the vehicle maintenance tracking server 108.

The software on the programmable controller 182 can be updated or replaced using a programming console 188, allowing for changes to the functionality of the vehicle usage tracker 156, including the intervals at which location and/or OBD data is retrieved and stored, as well as how and when the data is transmitted. In an exemplary embodiment of the vehicle usage tracker 156, the programmable controller 182 is a microcontroller with the software stored in an EEPROM memory built into the controller. The retrieved location data is stored in RAM or flash memory which may either be embedded into the controller or separate from it.

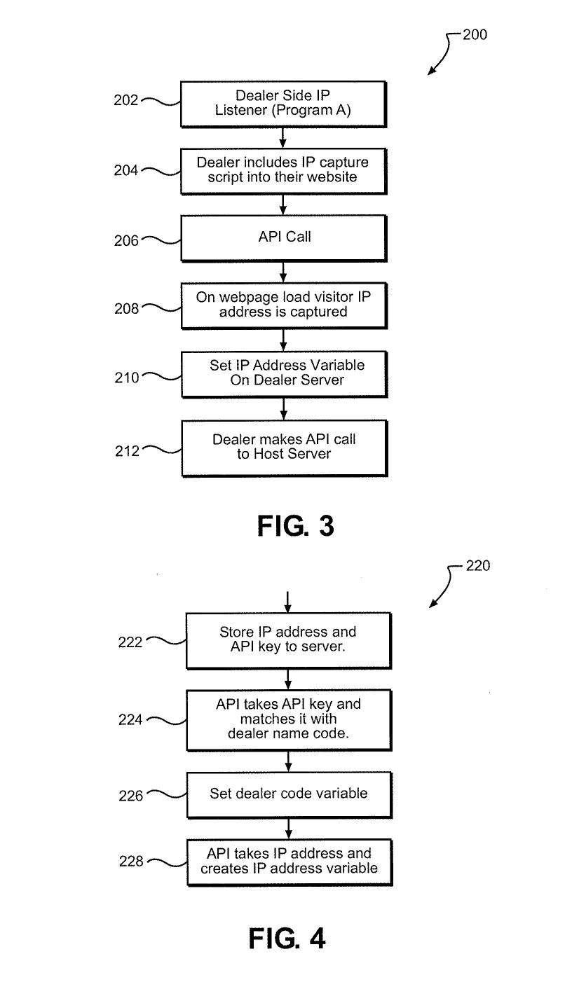

Referring now to FIG. 3, a diagram of the customer IP capturing module of the dealer website is shown and generally designated 200. The module operates through an IP listener program, program A 202, operating on the dealer website. The IP listener program 202 uses a script 204 that the dealer installs onto the dealer website. The script 204 may be a Javascript program actually stored on the vehicle maintenance tracking server 108 or another external server, in which case it is installed on the dealer website by inserting into the website a “script” HTML tag with the “type” attribute set to “text/javascript” and the “src” attribute set to the URL of the Javascript program stored on the vehicle maintenance tracking server 108. When a page on the dealer website is loaded, the script 204 runs and makes an API call 206 to the vehicle maintenance tracking server 108. Through the API call 206, the script 204 transfers the visitor's IP address 208, along with the visitor's city, to the vehicle maintenance tracking server 108. If a particular visitor's city cannot be acquired through the Javascript program, or in situations in which it may be undesirable to do so, it can be determined by the vehicle maintenance tracking server based on the IP address itself. The visitor's city is stored and later used to break down reports by city. More particularly, analytics such as the top cities based on number of visits per city may be provided.

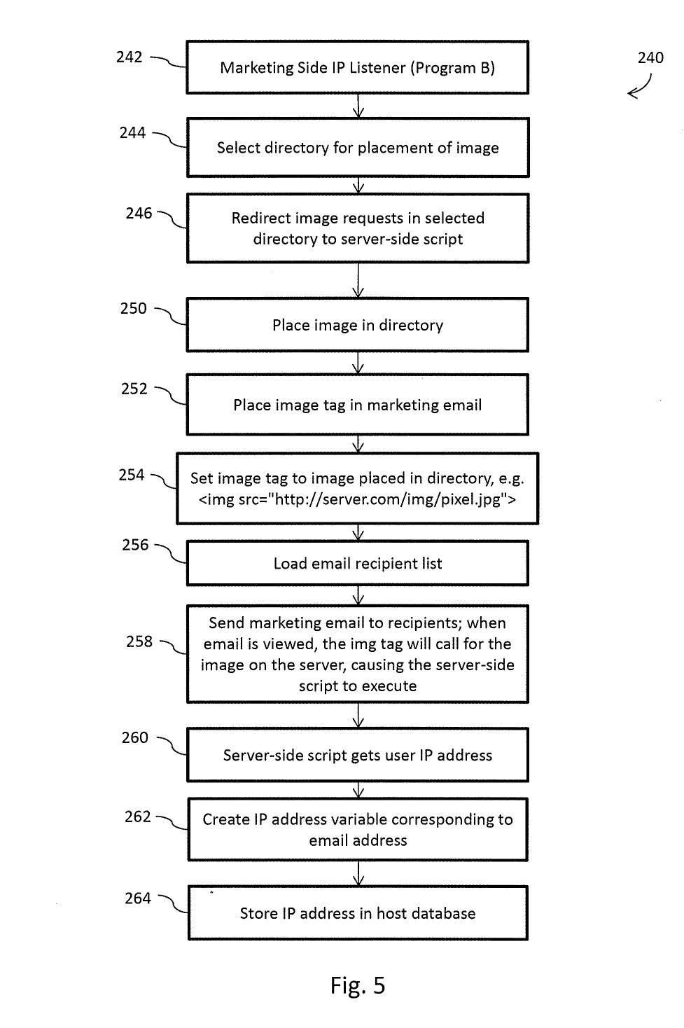

Referring now to FIG. 4, a diagram of the actions of the vehicle maintenance tracking server 108 in response to an API call 206 is shown and generally designated 220. The API call 206 from the script on the dealer's website provides the visitor's IP address and an API key corresponding to the dealer. The visitor's IP address is stored 222 to the vehicle maintenance tracking server 108 along with the API key. The API key is then matched 224 to the dealer. A variable is set 226 to identify the dealer, and an IP address variable is created 228. In this way, an IP address is associated with a visit to the dealer website on the vehicle maintenance tracking server 108, and is ready to be compared with IP addresses from an email marketing campaign associated with the dealer. The use of a unique API key and variable to identify the dealer allows the present invention to be used to provide service to multiple dealers at the same time.

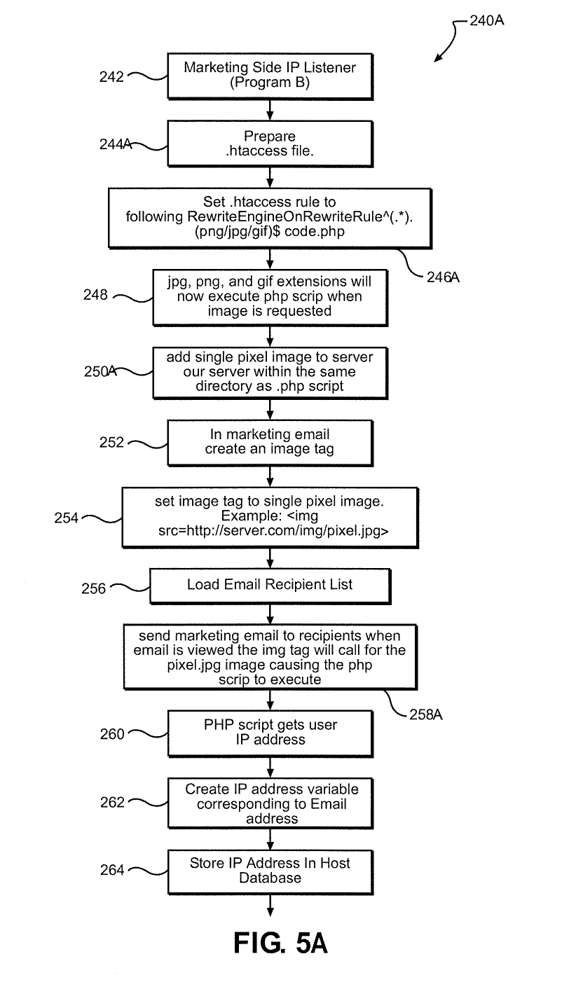

Referring now to FIG. 5, a diagram of the process of obtaining a customer IP address when an email message is opened is depicted and generally designated 240. A customer's IP address is obtained from an opened email through a marketing side IP listener program, program B 242. The marketing side server may be the vehicle maintenance tracking server 108 or another server in communication with it or with access to its database 134. A directory on the server is selected 244, and all HTTP requests for images in that directory will cause a server-side script to run 246. An image is also placed 250 in the directory, and will be sent by the script as a response to the HTTP request. In a preferred embodiment the image is a one (1) pixel by one (1) pixel image which is effectively invisible to the recipient. Other sizes of image will also work however. For example, a company logo may be used for in the heading or the footer of an email in place of the one pixel by one pixel image. An image tag will be placed 252 in the marketing email, and its “src” attribute set 254 to the image placed 250 in the selected directory 244 on the server. An email recipient list, such as the customer list 120 (as depicted in FIG. 1), is loaded 256, and the email is sent to recipients. When a recipient opens the email, the image is requested from the server, and the server-side script is run 258. Before sending the image as a response, the server-side script obtains 260 the recipient's IP address, and creates 262 an IP address variable associating the IP address to the email address. The IP address is then stored 264 in the database 134 as corresponding to the recipient's email address.

FIG. 5A depicts the process of FIG. 5 as implemented in PHP on an Apache web server. It will be apparent to those skilled in the art, however, that this process can be implemented in other programming languages and/or on other web servers without departing from the scope and spirit of the invention.

On the server, an .htaccess file or a directory entry in an initialization file is prepared 244A and includes a URL rewrite rule 246A such as the following:
RewriteEngine On
RewriteRule ̂(.*).(png/jpg/gif)$ code.php

When an image is requested 248 from the affected directory, the identified PHP script will run. A single pixel image is stored 250A in the same directory as the PHP script, and the PHP script will serve it in response to the request when complete. The email message sent to the customer includes an image tag 252, the “src” attribute of which is set 254 to the single pixel image. An email recipient list, such as the customer list 120 (as depicted in FIG. 1), is loaded 256, and the email is sent to recipients. When a recipient opens the email, the image is requested from the server, and the PHP script is run 258. Before sending the image as a response, the PHP script obtains 260 the recipient's IP address, and creates 262 an IP address variable associating the IP address to the email address. The IP address is then stored 264 in the database 134 as corresponding to the recipient's email address.

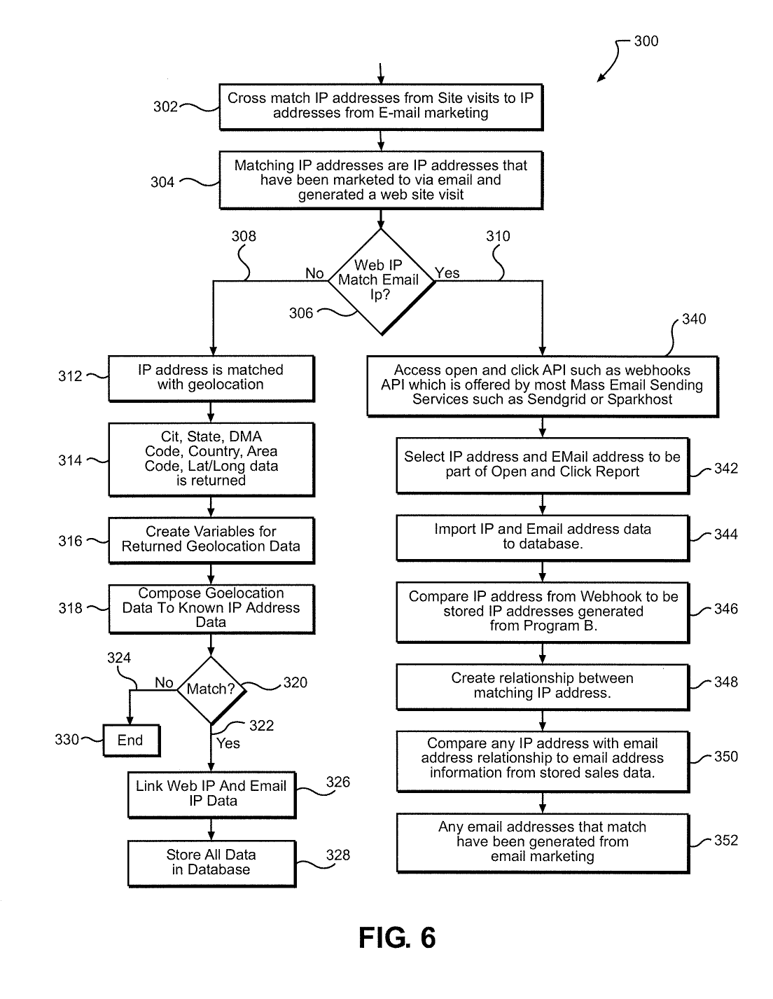

Referring now to FIG. 6, the process of matching a customer's identity between the marketing email and dealer website access or sales data from the dealer is depicted and generally designated 300. The vehicle maintenance tracking server, or another server in communication with it or with access to its database, attempts to match 302 IP addresses from site visits to those from email marketing efforts. The process 300 may occur at the time an API call 206 (shown in FIG. 3) is made, or it may be scheduled to run at predetermined intervals. For example, the process may be scheduled to run as a nightly cron job on the server in order to make use of the server's resources during non-peak hours.

When a match is found between an IP address from a website visit and an IP address obtained from an image request triggered by an image tag in a marketing email, the marketing email can be presumed to have generated 304 the web site visit. In order to determine whether a marketing email has generated a website visit, a database query 306 is made to determine whether the IP address from a dealer website visit matches an IP address obtained through a marketing email. If there is no initial match, a secondary search 308 is made to try to connect the IP address from the website visit to a known customer. Otherwise, customer data is loaded and linked 310 to the website access data.

In a secondary search 308, geolocation data for the IP address from the website visit is obtained 312. The geolocation query returns 314 the city, state, DMA code, country, area code, and latitude and longitude data associated with the IP address. On the server, variables are created 316 for the obtained geolocation data. The geolocation data is then compared 318 to data for known IP addresses, such as those obtained through marketing emails, in order to determine whether there is a match 320. If a match is found 322, the IP address from the website access is linked 326 to the IP address from the marketing email. Both IP addresses are stored 328 in the database 134 and associated with the same customer. If no match is found 324, the process terminates 330 for the particular IP address in question, and, if running a scheduled process, the server tries to match 304 the next website access IP address, if any remain.

When a website access IP address has a matching IP address obtained from an opened email, the website access data is linked 310 to existing customer data, and both are saved to the database 134. If the marketing email was sent through a third party service or platform, an API is used 340 to obtain the recipient's IP address and other information from the third party service. A database query 342 is performed to obtain 344 the IP address and corresponding email address from the database. If IP addresses are obtained both from a third party service and through in-house image tracking, the IP addresses obtained from the third party service are compared 346 with the IP addresses obtained in-house through program B 242, and a relationship between the records is formed 348. The email addresses are compared 350 with email addresses obtained from dealer sales data, and matches indicate sales generated from email marketing 352.

While there have been shown what are presently considered to be preferred embodiments of the present invention, it will be apparent to those skilled in the art that various changes and modifications can be made herein without departing from the scope and spirit of the invention.

1. A system for recording and analyzing vehicular data and providing targeted marketing to a customer, comprising:
a vehicle usage tracker having a GPS receiver, a controller, a memory, a serial number identifying the vehicle usage tracker, and a transmitter, said vehicle usage tracker in communication with an on board diagnostics port of a vehicle to retrieve and store diagnostic data;
a vehicle maintenance tracking server in communication with said vehicle usage tracker capable of receiving said diagnostic data; and
a means for analyzing said vehicle maintenance data and said diagnostic data to generate one or more alerts related to the condition of said vehicle for said customer.

2. The system for recording and analyzing vehicular data and providing targeted marketing to a customer as recited in claim 1, wherein said controller comprises a programmable microcontroller.

3. The system for recording and analyzing vehicular data and providing targeted marketing to a customer as recited in claim 2, wherein said programmable microcontroller comprises an EEPROM memory containing software instructions and a secondary memory comprising one or more memory structures selected from the group consisting of random access memory and flash memory, wherein said secondary memory is configured to store diagnostic data.

4. The system for recording and analyzing vehicular data and providing targeted marketing to a customer as recited in claim 1, wherein said one or more alerts comprises email alerts.

5. The system for recording and analyzing vehicular data and providing targeted marketing to a customer as recited in claim 4, wherein said email alerts are configured to obtain an IP address of a recipient.

6. The system for recording and analyzing vehicular data and providing targeted marketing to a customer as recited in claim 5, further comprising a website configured to obtain an IP address of a visitor and compare said IP address of said visitor to said IP address of said recipient in order to identify visitors to said website.

7. The system for recording and analyzing vehicular data and providing targeted marketing to a customer as recited in claim 1, wherein said vehicle usage tracker is further configured to retrieve and store GPS data from said GPS receiver.

8. The system for recording and analyzing vehicular data and providing targeted marketing to a customer as recited in claim 7, wherein said means for analyzing said vehicle maintenance data and said diagnostic data is further configured to associate said GPS data with climate data and modify a vehicle maintenance schedule based on said climate data.

9. The system for recording and analyzing vehicular data and providing targeted marketing to a customer as recited in claim 7, wherein said vehicle usage tracker is configured to retrieve and store GPS data in five-minute intervals.

10. The system for recording and analyzing vehicular data and providing targeted marketing to a customer as recited in claim 1, further comprising a customer relationship management system, wherein said means for analyzing said vehicle maintenance data and said diagnostic data forms part of said customer relationship management system.

11. A motor vehicle maintenance tracking system, comprising:
a vehicle usage tracker; and
a vehicle maintenance tracking server in communication with said vehicle usage tracker,
wherein said vehicle maintenance tracking server is configured to determine a maintenance schedule for a vehicle associated with said vehicle usage tracker.

12. The motor vehicle maintenance tracking system of claim 11, wherein said vehicle usage tracker is configured to retrieve and log diagnostic data through said vehicle's on board diagnostics port and provide said diagnostic data to said vehicle maintenance tracking server.

13. The motor vehicle maintenance tracking system of claim 12, wherein said vehicle maintenance tracking server is configured to use said diagnostic data to determine pending maintenance needs.

14. The motor vehicle maintenance tracking system of claim 13, wherein said vehicle usage tracker further comprises a GPS receiver and is configured to retrieve and log GPS data through said GPS receiver and provide said GPS data to said vehicle maintenance tracking server.

15. The motor vehicle maintenance tracking system of claim 14, wherein said vehicle maintenance tracking server is configured to use said GPS data to determine amount of use of said vehicle, type of use of said vehicle, and locations in which said vehicle is used, and compare said locations in which said vehicle is used with climate data.

16. The motor vehicle maintenance tracking system of claim 15, wherein said vehicle maintenance tracking server is configured to use mileage of said vehicle, said type of use of said vehicle, and said climate data in order to determine said maintenance schedule for said vehicle.

17. The motor vehicle maintenance tracking system of claim 16, wherein said vehicle maintenance tracking server is configured to send an email alert to a customer when said diagnostic data indicates a problem with said vehicle or when said vehicle is due for scheduled maintenance.

18. The motor vehicle maintenance tracking system of claim 17, wherein said vehicle maintenance tracking server is configured to send an alert to a dealer when an alert is sent to said customer.

19. The motor vehicle maintenance tracking system of claim 18, further comprising a customer relationship management system and marketing platform.

20. The motor vehicle maintenance tracking system of claim 11, further comprising means for updating software on said vehicle usage tracker.
